(19) United States
(12) Patent Application Publication
(10) Pub. No.: US 2025/0380069 A1
(43) Pub. Date: Dec. 11, 2025

(54) AUDIO SPEAKER WITH INTEGRATED ANTENNA

(71) Applicant: TAOGLAS GROUP HOLDINGS LIMITED, Enniscorthy (IE)

(72) Inventors: Argy Petros, Pompano Beach, FL (US); Hendrik Abraham Johannes Theron, Boca Raton, FL (US)

(21) Appl. No.: 19/228,193

(22) Filed: Jun. 4, 2025

Related U.S. Application Data
(60) Provisional application No. 63/657,594, filed on Jun. 7, 2024.

(51) Int. Cl. H04R 1/02

(52) U.S. Cl. CPC H04R 1/02; H04R 2400/11; H04R 2420/07

(57) ABSTRACT

An audio speaker with an integrated antenna is disclosed. In one embodiment, the audio speaker includes a speaker frame that supports a speaker cone and a speaker dust cap and an antenna subassembly is disposed concentrically within the speaker cone. In one variant, the antenna subassembly further includes a first antenna element that is connected with a ground of a coaxial cable and a second antenna element that is connected with a feed of the coaxial cable. In some variants, the antenna subassembly is attached directly to the speaker frame. The antenna subassembly may include an antenna substrate that is coupled with an antenna cover. A coaxial cable is received within the antenna cover and is attached to the antenna substrate.

### CROSS-REFERENCE TO RELATED APPLICATIONS

This application claims the benefit of priority to U.S. Provisional Patent Application Ser. No. 63/657,594 filed Jun. 7, 2024, of the same title, the contents of which being incorporated herein by reference in its entirety.

### TECHNOLOGICAL FIELD

The present disclosure relates generally to audio speakers with an integrated antenna, and more particularly in one exemplary aspect to an audio speaker with integrated WiFi and/or Long-Term Evolution (LTE) antennas.

### FIELD OF THE DISCLOSURE

More recently, automobiles that offer internet connectivity through WiFi and/or LTE communication protocols have become appealing to vehicle owners as these capabilities provide a convenient internet connection that allows people to, inter alia, make hands-free calls, receive live traffic updates for easier navigation, receive updated weather reports, and provide access to emergency services. Additionally, long road trips become more enjoyable as passengers may enjoy their internet access to view movies, play games and otherwise enjoy broad internet connectivity. Automobiles that offer internet connectivity often require multiple WiFi/LTE antennas to provide this internet connectivity. These antennas are hidden and placed in various parts of the interior of the vehicle and are oftentimes required to be placed in specific locations that are suitable for good antenna performance. However, these antenna installations add to the overall vehicle cost due to the additional labor required for their installation. Accordingly, new techniques are needed to minimize this additional labor, thereby minimizing costs and increasing access to automobiles with internet connectivity.

### SUMMARY

The present disclosure satisfies the foregoing needs by providing, inter alia, methods, apparatus and systems for the implementation of antennas within vehicles that address the deficiencies recognized above.

In one aspect an audio speaker with an integrated antenna is disclosed. In one embodiment, the audio speaker includes a speaker frame that supports a speaker cone and a speaker dust cap; and an antenna subassembly disposed concentrically within the speaker cone.

In one variant, the antenna subassembly further includes a first antenna element that is connected with a ground of a coaxial cable, the first antenna element having: a first radiating arm; a second radiating arm; and a third radiating arm; and a second antenna element that is connected with a feed of the coaxial cable, the second antenna element having: a fourth radiating arm; a fifth radiating arm; and a sixth radiating arm. the fifth radiating arm is longer in length than the second radiating arm, and the third radiating arm is longer in length than the fourth radiating arm.

In another variant, the audio speaker includes a coaxial cable, and the first antenna element is coupled with a ground portion of the coaxial cable and the second antenna element is coupled with a feed portion of the coaxial cable.

In yet another variant, the third radiating arm generally runs orthogonal to the first radiating arm and the second radiating arm.

In yet another variant, the first radiating arm, the second radiating arm, and the third radiating arm collectively form an inverted F-type shape.

In yet another variant, the fourth radiating arm generally runs orthogonal to the fifth radiating arm and the sixth radiating arm.

In yet another variant, the fourth radiating arm, the fifth radiating arm, and the sixth radiating arm collectively form an F-type shape.

In yet another variant, the third radiating arm comprises an L-type shape, with one end of the L-type shape being connected with the ground portion of the coaxial cable and an opposing end of the L-type shape being connected with the first radiating arm and the second radiating arm.

In yet another variant, the fourth radiating arm comprises an L-type shape, with one end of the L-type shape being connected with the feed portion of the coaxial cable and an opposing end of the L-type shape being connected with the fifth radiating arm and the sixth radiating arm.

In yet another variant, the first radiating arm is longer in length than the second radiating arm.

In yet another variant, the sixth radiating arm is longer in length than the fifth radiating arm.

In yet another variant, the first radiating arm runs collinear and coplanar with the second radiating arm.

In yet another variant, the second radiating arm runs collinear and coplanar with the fifth radiating arm.

In yet another variant, the speaker frame further supports a yoke, a magnet, and a voice coil of the audio speaker.

In yet another variant, the coaxial cable runs through the yoke, the magnet and the voice coil of the audio speaker.

In yet another variant, the speaker cone has a circular shape.

In yet another variant, the speaker cone comprises an ovular shape.

In another embodiment, the audio speaker with an integrated antenna may include a speaker frame that supports a speaker cone and a speaker dust cap. The speaker frame may include an antenna subassembly that includes an antenna cover that is mounted directly to the speaker frame.

In another aspect, an antenna subassembly for use in an audio speaker is disclosed. In one embodiment, the antenna subassembly includes a first antenna element that is connected with a ground of a coaxial cable and a second antenna element that is connected with a feed of the coaxial cable. In another variant, the first antenna element includes a first radiating arm, a second radiating arm, and a third radiating arm. The second antenna element may also include a fourth radiating arm, a fifth radiating arm, and a sixth radiating arm. The sixth radiating arm is longer in length than the first radiating arm, the fifth radiating arm is longer in length than the second radiating arm, and the third radiating arm is longer in length than the fourth radiating arm.

In yet another aspect, methods of manufacturing the aforementioned audio speaker are also disclosed.

In yet another aspect, methods of manufacturing an antenna subassembly are also disclosed.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1A is a perspective view of a first embodiment of an audio speaker with integrated antenna, in accordance with the principles of the present disclosure.

FIG. 1B is a side elevation view of the audio speaker with integrated antenna of FIG. 1A, in accordance with the principles of the present disclosure.

FIG. 1C is a cross-sectional view taken along lines 1C-1C of the audio speaker with integrated antenna of FIG. 1A, in accordance with the principles of the present disclosure.

FIG. 1D is a detailed view of the antenna integrated within the audio speaker of FIG. 1A, in accordance with the principles of the present disclosure.

FIG. 2A is a perspective view of a second embodiment of an audio speaker with integrated antenna, in accordance with the principles of the present disclosure.

FIG. 2B is a side elevation view of the audio speaker with integrated antenna of FIG. 2A, in accordance with the principles of the present disclosure.

FIG. 2C is a cross-sectional view taken along lines 2C-2C of the audio speaker with integrated antenna of FIG. 2A, in accordance with the principles of the present disclosure.

FIG. 2D is a detailed view of the antenna integrated within the audio speaker of FIG. 2A, in accordance with the principles of the present disclosure.

FIG. 3A is a back side view of a third embodiment of an audio speaker with integrated antenna, in accordance with the principles of the present disclosure.

FIG. 3B is a side elevation view of the audio speaker with integrated antenna of FIG. 3A, in accordance with the principles of the present disclosure.

FIG. 3C is a cross-sectional view taken along lines 3C-3C of the audio speaker with integrated antenna of FIG. 3A, in accordance with the principles of the present disclosure.

FIG. 3D is a perspective view of the Wi-Fi antenna assembly for use with the audio speaker with integrated antenna of FIG. 3A, in accordance with the principles of the present disclosure.

FIG. 3E is a detailed view of the antenna substrate for the Wi-Fi antenna assembly for use with the audio speaker with integrated antenna of FIG. 3A, in accordance with the principles of the present disclosure.

### DETAILED DESCRIPTION

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of WiFi/LTE antennas as well as exemplary systems that integrate these WiFi/LTE antennas within audio speakers for purposes of illustration only. One skilled in the art will readily recognize from the following description that alternative embodiments of the structures and methods illustrated herein may be employed without necessarily departing from the principles described herein.

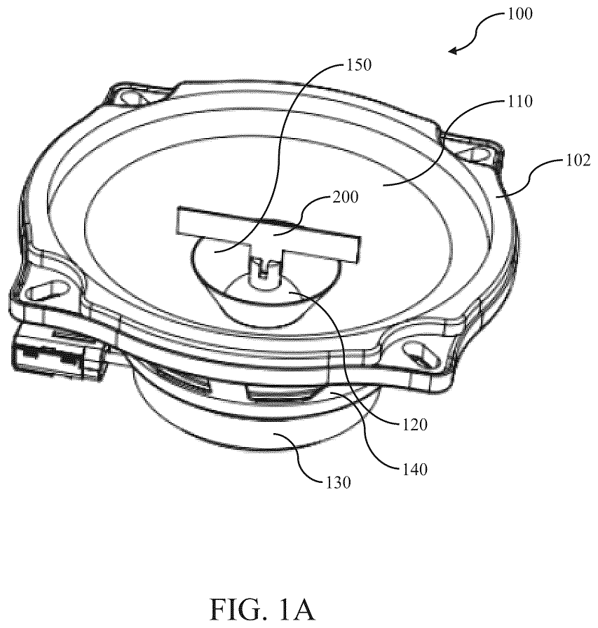

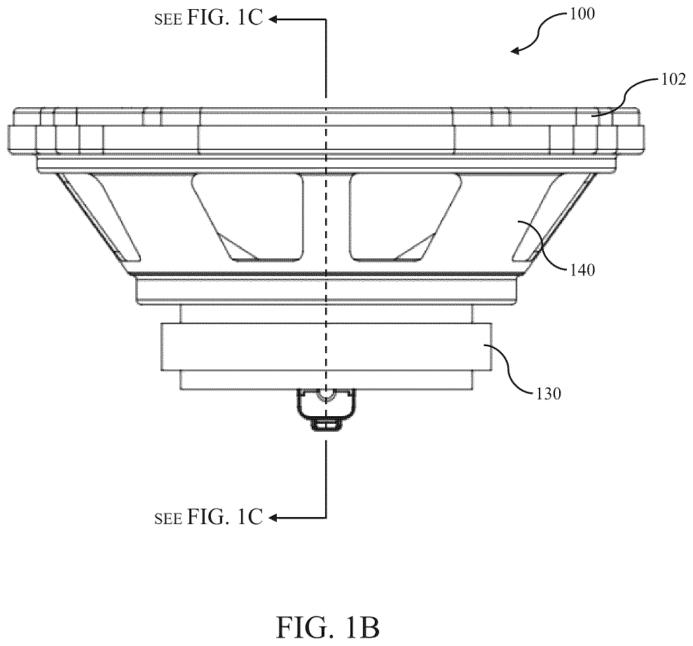

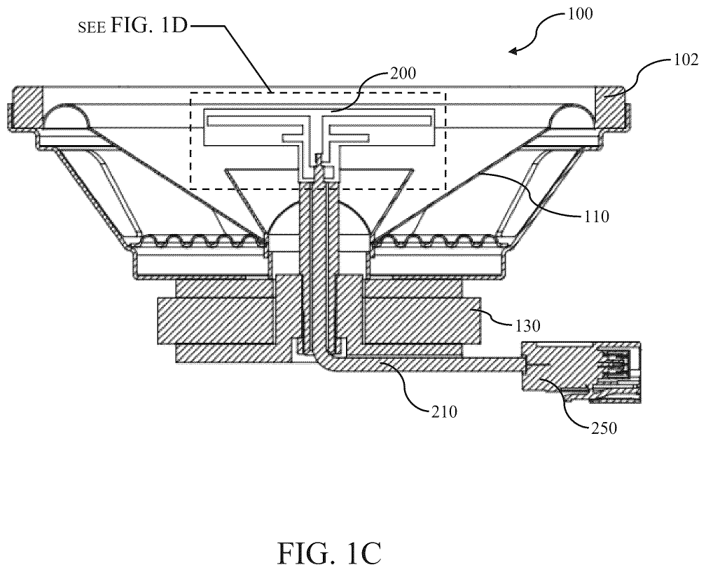

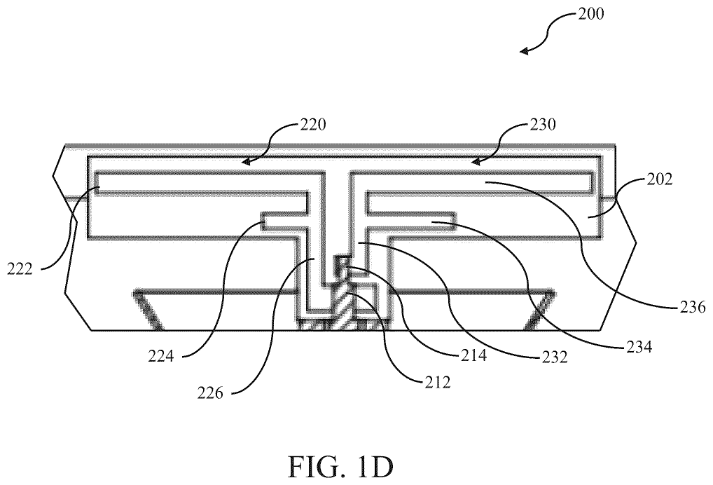

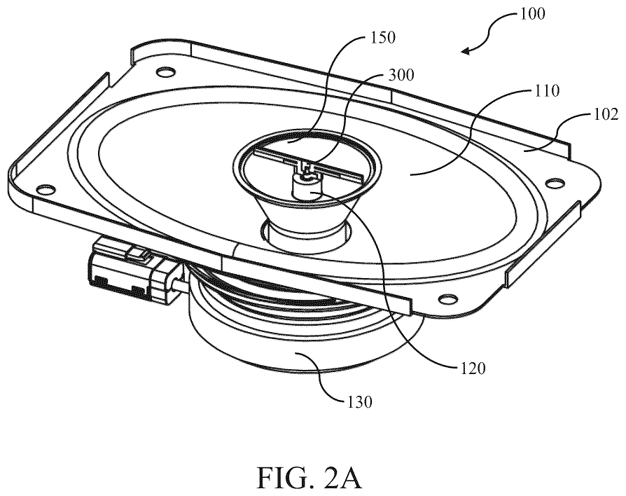

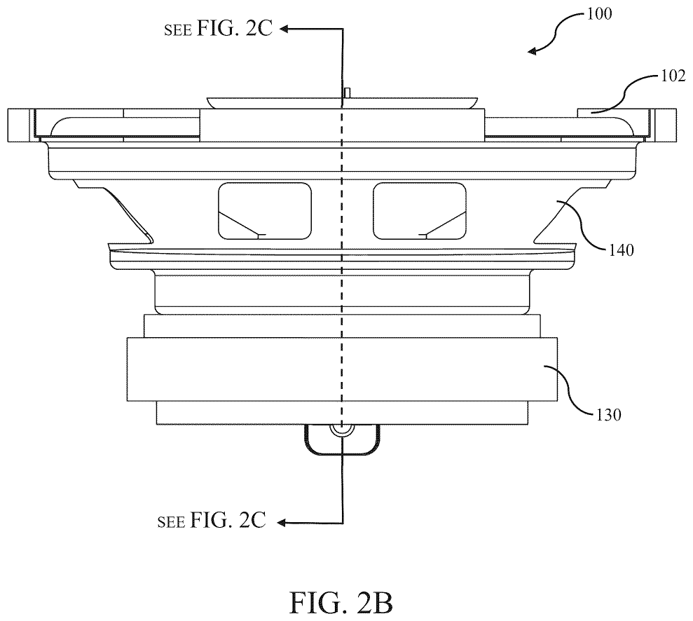

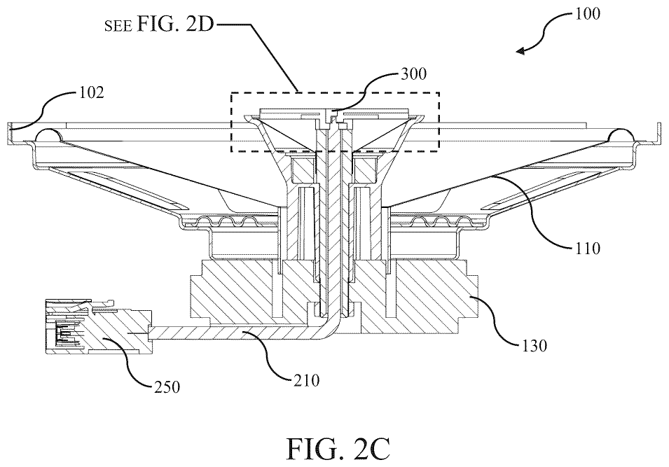

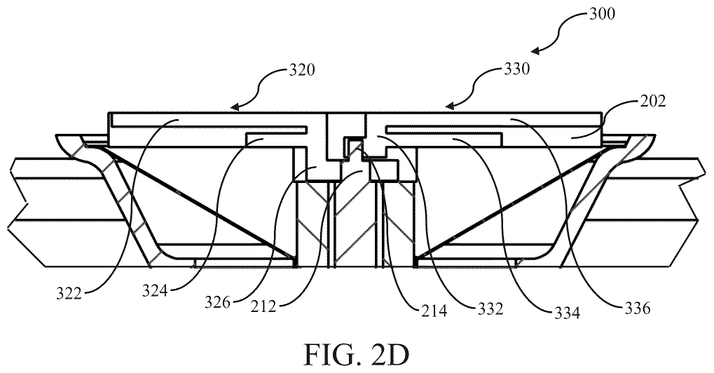

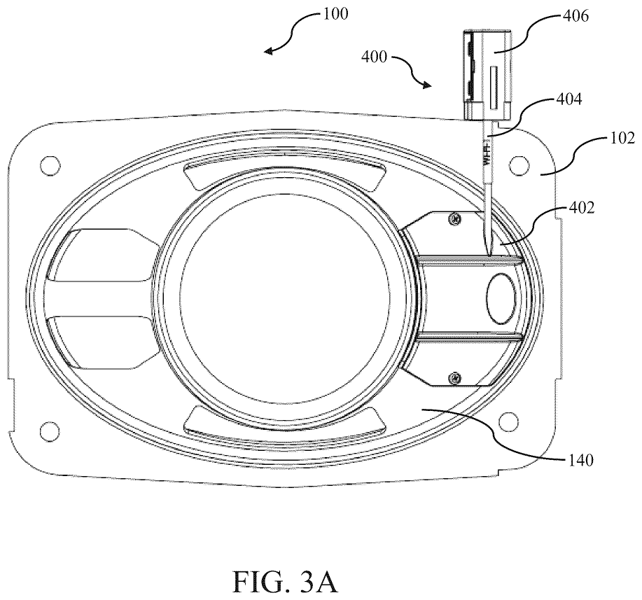

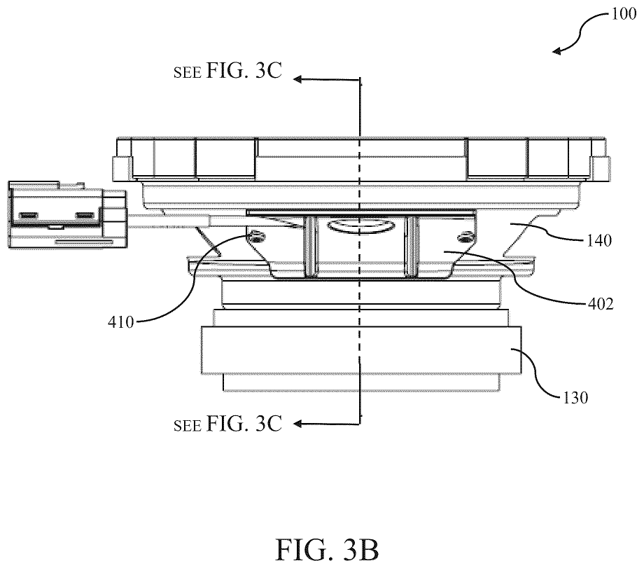

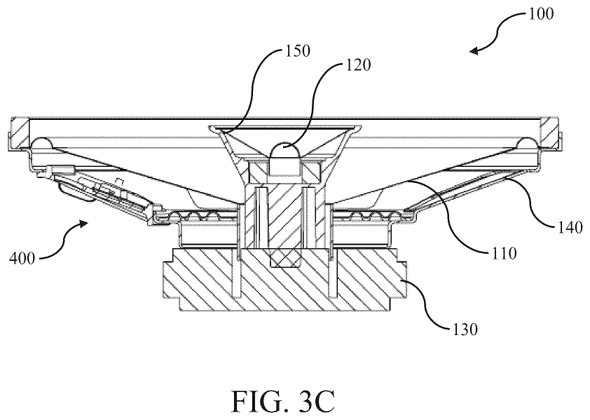

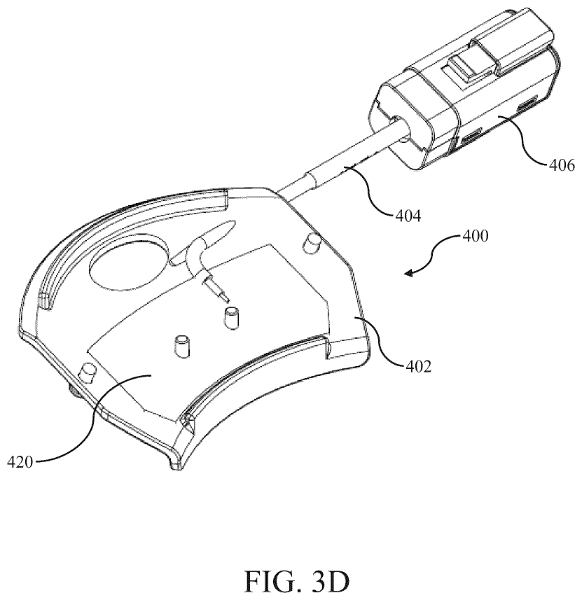

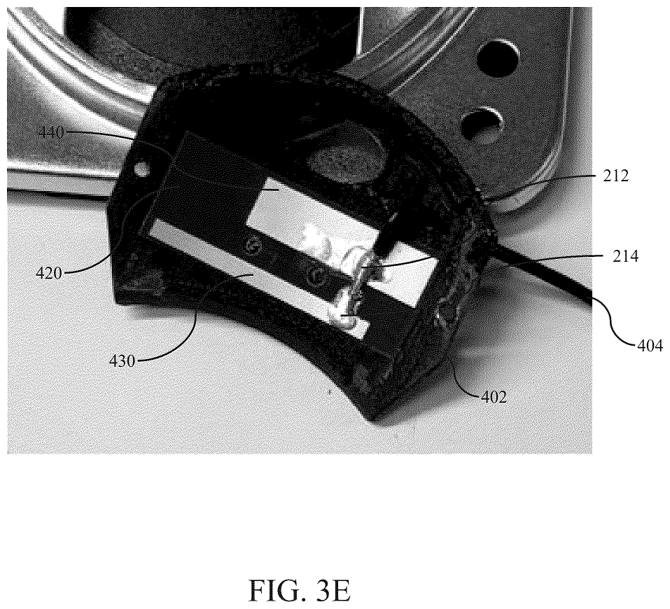

While the embodiments described herein primarily describe antenna elements that are placed concentrically around the damper and dust cap of an audio speaker, it would be readily apparent to one of ordinary skill given the contents of the present disclosure that other suitable locations of the audio speaker may be utilized to accommodate the antenna elements described herein (see e.g., FIGS. 3A-3E). For example, it is envisioned that the antenna elements may be integrated around the perimeter of the speaker (e.g., around the perimeter of the speaker cone), may be integrated on the cone of the speaker, may be integrated around the tweeter of the speaker, and/or may be integrated within the speaker frame. Moreover, while a specific antenna design is shown and described with respect to FIGS. 1D, 2D, and 3E, it would be readily apparent to one of ordinary skill given the contents of the present disclosure that alternative antenna artwork and/or alternative antenna architectural designs may be readily substituted in favor of the specific designs described herein. For example, the antenna artwork illustrated in FIGS. 1D and 2D may be bodily incorporated into the speaker antenna assembly illustrated in FIGS. 3A-3D.

Exemplary Audio Speaker with Integrated Antenna—

Referring now to FIGS. 1A-1D, various views of a first embodiment of a speaker antenna assembly 100 are shown. As shown in FIG. 1A, the speaker 102 itself may take on a conventional circular form and may include a speaker cone 110, a speaker dust cap 120, a speaker magnet 130, a speaker frame 140, and a tweeter 150. The speaker 102 may also include an antenna 200 which may be located concentrically around the damper and dust cap 120 of the speaker 102. Referring now to FIG. 1C, the method by which the antenna 200 is installed within the speaker 102 is more readily apparent. Specifically, a radio frequency (RF) pigtail cable 210 is routed through the center of the speaker 102 such that it runs through the yoke, magnet 130, and voice coil of the speaker 102 and exits at the speaker bottom. In some implementations, the RF pigtail cable 210 may be a coaxial cable. The use of a coaxial cable design for the RF pigtail cable 210 may be advantageous as the signals being transmitted through the RF pigtail cable 210 may be shielded from external electromagnetic interference (EMI) which may be generated from, for example, the voice coil of the speaker 102. One end of the RF pigtail cable 210 may be attached to the antenna 200 as will be discussed in further detail herein, while the other end of the RF pigtail cable 210 may include an RF connector 250. In some implementations, the RF connector 250 is a Fachkreis Automobil (“FAKRA”) Subminiature version B (“SMB”) connector with a housing, although other suitable RF connectors may be utilized in alternative embodiments. The FAKRA SMB connector may be advantageous as this type of RF connector is often utilized in automobile applications.

Referring now to FIGS. 2A-2D, various views of a second embodiment of a speaker antenna assembly 100 are shown. As shown in FIG. 2A, the speaker 102 itself may take on a conventional oval form and may include a speaker cone 110, a speaker dust cap 120, a speaker magnet 130, a speaker frame (140, FIG. 2B), and a tweeter 150. The speaker 102 may also include an antenna 300 which may be located concentrically around the damper and dust cap 120 of the speaker 102. Referring now to FIG. 2C, the method by which the antenna 300 is installed within the speaker 102 is more readily apparent. Specifically, a radio frequency (RF) pigtail cable 210 is routed through the center of the speaker 102 such that it runs through the yoke, magnet 130, and voice coil of the speaker 102 and exits at the speaker bottom. In some implementations, the RF pigtail cable 210 may be a coaxial cable. The use of a coaxial cable design for the RF pigtail cable 210 may be advantageous as the signals being transmitted through the RF pigtail cable 210 may be shielded from external electromagnetic interference (EMI) which may be generated from, for example, the voice coil of the speaker 102. One end of the RF pigtail cable 210 may be attached to the antenna 300 as will be discussed in further detail herein, while the other end of the RF pigtail cable 210 may include an RF connector 250.

Referring now to FIGS. 3A-3E, various views of a third embodiment of a speaker antenna assembly 100 are shown. As shown in FIG. 3A, the speaker 102 itself may take on a conventional ovular form although other variants could take the form of other conventional speaker form factors such as, for example, circular form factors as shown in, for example, FIG. 1A. However, unlike the embodiments depicted in FIGS. 1A-2D, the Wi-Fi antenna assembly 400 is not mounted concentrically within the body of the speaker 102. Rather, the Wi-Fi antenna assembly 400 is connected to the speaker frame 140 on a side portion of the speaker 102. Specifically, the Wi-Fi antenna cover 402 is connected to the speaker frame 140 (as shown in FIG. 3B) via the use of threaded fasteners 410. However, other connection methodologies for connecting the Wi-Fi antenna assembly 400 to the speaker 102 may use items such as rivets, heat staking methodologies, and/or adhesives. The Wi-Fi antenna assembly 400 may also include a coaxial cable 404 that is positioned between the Wi-Fi antenna cover 402 and the RF connector 406. In some implementations, the RF connector 406 may be a FAKRA SMB connector, although other suitable RF connectors may be utilized in alternative embodiments. Referring to FIG. 3C, the speaker antenna assembly 100 may include a speaker cone 110, a speaker dust cap 120, a speaker magnet 130, a speaker frame 140, and a tweeter 150. As shown in FIG. 3D, the Wi-Fi antenna cover 402 may be used for the mounting of the antenna substrate 420, which will be described in additional detail with respect to FIG. 3E discussed infra.

### Exemplary Integrated Antenna Design—

Referring now to FIG. 1D, a first exemplary antenna 200 for use with, for example, the speaker antenna assembly 100 of FIGS. 1A-1C is shown and described in detail. The antenna 200 may consist of conductive artwork that is formed or otherwise disposed on a dielectric substrate 202. The dielectric substrate 202 may be manufactured from, for example, fiberglass and/or a ceramic-based material. The underlying antenna artwork may include a first antenna element 220 as well as a second antenna element 230. The first antenna element 220 may be connected with RF ground 212, while the second antenna element 230 may be connected with the RF feed 214. The first antenna element 220 may not be galvanically connected with the second antenna element 230. As shown, the antenna 200 may consist of a printed dipole antenna, although other suitable printed PCB antennas may be utilized in alternative implementations such as, for example, wire antennas.

The first antenna element 220 may include a first radiating arm 222, a second radiating arm 224, and a third radiating arm 226. The three radiating arms 222, 224, 226 may collectively resemble a backwards letter “F”. The first radiating arm may be longer in length than both the second radiating arm 224 and the third radiating arm 226. The third radiating arm 226 may be longer in length than the second radiating arm 224. The second radiating arm 224 may be oriented in parallel with the first radiating arm 222, while the first radiating arm 222 and the second radiating arm 224 may be oriented orthogonal with the third radiating arm 226. The second antenna element 230 may include a fourth radiating arm 232, a fifth radiating arm 234, and a sixth radiating arm 236. These three radiating arms 232, 234, 236 may collectively resemble the letter “F”. In other words, the first antenna element 220 may generally resemble the second antenna element 230, albeit reversed in orientation. The sixth radiating arm 236 may be longer in length than both the fifth radiating arm 234 and the fourth radiating arm 232. The fifth radiating arm 234 may be longer in length than the fourth radiating arm 232. The sixth radiating arm 236 may be longer in length as compared with the first radiating arm 222. Similarly, the fifth radiating arm 234 may be longer in length as compared with the second radiating arm 224. However, the fourth radiating arm 232 may be shorter in length as compared with the third radiating arm 226. The fifth radiating arm 234 may be parallel with the sixth radiating arm 236, while both the fifth radiating arm 234 and the sixth radiating arm 236 may be oriented orthogonal with the fourth radiating arm 232.

Referring now to FIG. 2D, a second exemplary antenna 300 for use with, for example, the speaker antenna assembly 100 of FIGS. 2A-2C is shown and described in detail. The antenna 300 may consist of conductive artwork that is formed or otherwise disposed on a dielectric substrate 202. As shown, the antenna 300 may consist of a printed dipole antenna, although other suitable printed PCB antennas may be utilized in alternative implementations such as, for example, wire antennas. The dielectric substrate 202 may be manufactured from, for example, fiberglass and/or a ceramic-based material. The underlying antenna artwork may include a first antenna element 320 as well as a second antenna element 330. The first antenna element 320 may be connected with RF ground 212, while the second antenna element 330 may be connected with the RF feed 214. Similar to antenna 200 shown in FIG. 1D, the first antenna element 320 may not be galvanically connected with the second antenna element 330. However, the second exemplary antenna 300 may be more compressed in the vertical direction than the first exemplary antenna 200.

Similar to the first exemplary antenna 200 illustrated in FIG. 1D, the first antenna element 320 may include a first radiating arm 322, a second radiating arm 324, and a third radiating arm 326. The three radiating arms 322, 324, 326 may collectively resemble a backwards letter “F”. The first radiating arm 322 may be longer in length than both the second radiating arm 324 and the third radiating arm 326. The third radiating arm 326 may be shorter in length than the second radiating arm 324. The second radiating arm 324 may be oriented in parallel with the first radiating arm 322, while the first radiating arm 322 and the second radiating arm 324 may be oriented orthogonal with the third radiating arm 326. The second antenna element 330 may include a fourth radiating arm 332, a fifth radiating arm 334, and a sixth radiating arm 336. These three radiating arms 332, 334, 336 may collectively resemble the letter “F”. In other words, the first antenna element 320 may resemble the second antenna element 330, albeit reversed in orientation. The sixth radiating arm 336 may be longer in length than both the fifth radiating arm 334 and the fourth radiating arm 332. The fifth radiating arm 334 may be longer in length than the fourth radiating arm 332. The sixth radiating arm 336 may be longer in length as compared with the first radiating arm 322. Similarly, the fifth radiating arm 334 may be longer in length as compared with the second radiating arm 324. However, the fourth radiating arm 332 may be shorter in length as compared with the third radiating arm 326. The fifth radiating arm 334 may be parallel with the sixth radiating arm 336, while both the fifth radiating arm 334 and the sixth radiating arm 336 may be oriented orthogonal with the fourth radiating arm 332.

Referring now to FIG. 3E, yet another example of an antenna implementation for use with the embodiment of FIGS. 3A-3D is shown and described in detail. Specifically, the antenna substrate 420 may include a ground portion 440 as well as a radiating portion 430. The ground portion 440 may be connected to the radio frequency ground 212 of the coaxial cable 404. The radiating portion 430 may be connected to the radio frequency feed 214 of the coaxial cable 404. The coaxial cable 404 may penetrate the antenna cover 402 on the opposite side of the antenna substrate 420 mounting surface. The antenna substrate 420 may be mounted on the antenna cover 402 using, for example, bosses. The antenna substrate 420 may be curved to conform to the underlying geometry of the antenna cover 402 and the speaker 102. While a specific conductive artwork structure is shown in FIG. 3E, it would be readily appreciated that alternative variants may include the artwork depicted in FIG. 1D or 2D in some variants.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. An audio speaker with an integrated antenna, the audio speaker comprising:
a speaker frame that supports a speaker cone and a speaker dust cap; and
an antenna subassembly disposed concentrically within the speaker cone.

2. The audio speaker of claim 1, wherein the antenna subassembly further comprises:
a first antenna element that is connected with a ground of a coaxial cable, the first antenna element comprising:
a first radiating arm;
a second radiating arm; and
a third radiating arm; and
a second antenna element that is connected with a feed of the coaxial cable, the second antenna element comprising:
a fourth radiating arm;
a fifth radiating arm; and
a sixth radiating arm;
wherein the fifth radiating arm is longer in length than the second radiating arm, and the third radiating arm is longer in length than the fourth radiating arm.

3. The audio speaker of claim 2, further comprising a coaxial cable, wherein the first antenna element is coupled with a ground portion of the coaxial cable and the second antenna element is coupled with a feed portion of the coaxial cable.

4. The audio speaker of claim 3, wherein the third radiating arm generally runs orthogonal to the first radiating arm and the second radiating arm.

5. The audio speaker of claim 3, wherein the first radiating arm, the second radiating arm, and the third radiating arm collectively comprise an inverted F-type shape.

6. The audio speaker of claim 5, wherein the fourth radiating arm generally runs orthogonal to the fifth radiating arm and the sixth radiating arm.

7. The audio speaker of claim 6, wherein the fourth radiating arm, the fifth radiating arm, and the sixth radiating arm collectively comprise an F-type shape.

8. The audio speaker of claim 7, wherein the third radiating arm comprises an L-type shape, with one end of the L-type shape being connected with the ground portion of the coaxial cable and an opposing end of the L-type shape being connected with the first radiating arm and the second radiating arm.

9. The audio speaker of claim 8, wherein the fourth radiating arm comprises an L-type shape, with one end of the L-type shape being connected with the feed portion of the coaxial cable and an opposing end of the L-type shape being connected with the fifth radiating arm and the sixth radiating arm.

10. The audio speaker of claim 9, wherein the first radiating arm is longer in length than the second radiating arm.

11. The audio speaker of claim 10, wherein the sixth radiating arm is longer in length than the fifth radiating arm.

12. The audio speaker of claim 11, wherein the first radiating arm runs collinear and coplanar with the second radiating arm.

13. The audio speaker of claim 12, wherein the second radiating arm runs collinear and coplanar with the fifth radiating arm.

14. The audio speaker of claim 13, wherein the speaker frame further supports a yoke, a magnet, and a voice coil of the audio speaker.

15. The audio speaker of claim 14, wherein the coaxial cable runs through the yoke, the magnet and the voice coil of the audio speaker.

16. The audio speaker of claim 15, wherein the speaker cone comprises a circular shape.

17. The audio speaker of claim 15, wherein the speaker cone comprises an ovular shape.

18. An audio speaker with an integrated antenna, the audio speaker comprising:
a speaker frame that supports a speaker cone and a speaker dust cap; and
an antenna subassembly comprising an antenna cover that is connected to the speaker frame.

19. The audio speaker of claim 18, further comprising a coaxial cable, the coaxial cable penetrating an outside surface of the antenna cover and being coupled with an antenna located internal to the antenna cover.

20. The audio speaker of claim 19, wherein the antenna comprises two discrete metallizations, a first of the two discrete metallizations being coupled with a feed portion of the coaxial cable and a second of the two discrete metallizations being coupled with a ground portion of the coaxial cable.
